(19) United States
(12) Patent Application Publication
(10) Pub. No.: US 2026/0212547 A1
(43) Pub. Date: Jul. 23, 2026

(54) EFFECT IMAGE GENERATION METHOD, DEVICE AND STORAGE MEDIUM

(71) Applicant: Beijing Zitiao Network Technology Co., Ltd., Haidian District, Beijing (CN)

(72) Inventor: Meng YAN, Beijing (CN)

(21) Appl. No.: 19/141,176

(22) PCT Filed: Dec. 1, 2023
(86) PCT No.: PCT/CN2023/135943

§ 371 Date: Jun. 19, 2025

(30) Foreign Application Priority Data
Dec. 20, 2022 (CN) 202211643718.3

(51) Int. Cl. G06T 11/10; G06T 11/40

(52) U.S. Cl. CPC G06T 11/10; G06T 11/40

(57) ABSTRACT

Provided in the embodiments of the present disclosure are an effect image generation method, a device, and a storage medium. The effect image generation method includes: generating target distance field information at a current moment; performing effect processing on an image based on the target distance field information, so as to obtain a first effect image; and performing a color transformation on the first effect image based on the target distance field information, so as to obtain a second effect image.

The present application claims priority to the Chinese patent application No. 202211643718.3 filed on Dec. 20, 2022, the disclosure of which is incorporated herein by reference in its entirety as part of the present application.

### TECHNICAL FIELD

Embodiments of the present disclosure relate to a generation method and apparatus for an effect image, a device and a storage medium.

### BACKGROUND

In recent years, image processing applications (APP) have developed rapidly, come into the lives of users, and gradually enriched their spare time. The users may record their lives in the form of videos, photos, etc., and may reprocess images through effect technologies provided on the image processing APPs, so that the images may be expressed in a richer form. In related technology, the content of the generated effect images is not rich enough.

### SUMMARY

Embodiments of the present disclosure provide a generation method and apparatus for an effect image, a device and a storage medium, in which an effect image with a water drop effect may be generated based on distance field information, the content of the image is enriched, and the display effect of the image is improved.

In a first aspect, embodiments of the present disclosure provide a generation method for an effect image, comprising:
generating target distance field information at a current moment;
performing effect processing on an original image based on the target distance field information, so as to obtain an initial effect image; and
performing a color transformation on the initial effect image based on the target distance field information, so as to obtain a target effect image, comprising:

In a second aspect, embodiments of the present disclosure provide a generation apparatus for an effect image, comprising:
a target distance field information generation module configured to generate target distance field information at a current moment;
an initial effect image acquisition module configured to perform effect processing on an original image based on the target distance field information, so as to obtain an initial effect image; and
a target effect image acquisition module configured to perform a color transformation on the initial effect image based on the target distance field information, so as to obtain a target effect image.

In a third aspect, embodiments of the present disclosure provide an electronic device, comprising:
one or more processors; and
a storage device configured to store one or more computer programs,
wherein when the one or more computer programs are executed by the one or more processors, the one or more processors implement the generation method for the effect image according to embodiments of the present disclosure.

In a fourth aspect, embodiments of the present disclosure provide a storage medium containing computer-executable instructions, wherein the computer-executable instructions, when executed by a computer processor, implement the generation method for the effect image according to embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a schematic flowchart of a flow of a generation method for an effect image according to an embodiment of the present disclosure;

FIG. 2a is a schematic diagram of a circular distance field according to an embodiment of the present disclosure;

FIG. 2b is a schematic diagram of four circular distance fields after fusion according to an embodiment of the present disclosure;

FIG. 2c is an example diagram of a fused distance field according to an embodiment of the present disclosure;

FIG. 3a is an example diagram of an initial effect image according to an embodiment of the present disclosure;

FIG. 3b is an example diagram of a fuzzy effect image according to an embodiment of the present disclosure;

FIG. 3c is an example diagram of a color image corresponding to an initial effect image according to an embodiment of the present disclosure;

FIG. 3d is an example diagram of a target effect image according to an embodiment of the present disclosure;

FIG. 4 is a structural schematic diagram of a generation apparatus for an effect image according to an embodiment of the present disclosure; and

FIG. 5 is a structural schematic diagram of an electronic device according to an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are only for exemplary purposes, and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, when receiving an active request from a user, a prompt message is sent to the user to explicitly prompt the user that an operation requested by the user will need to obtain and use the user's personal information. In this way, the user may choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

It may also be understood that the data (including but not limited to the data itself, data acquisition, or use) involved in the technical solutions of the present disclosure shall comply with the requirements of the corresponding laws, regulations, and related provisions.

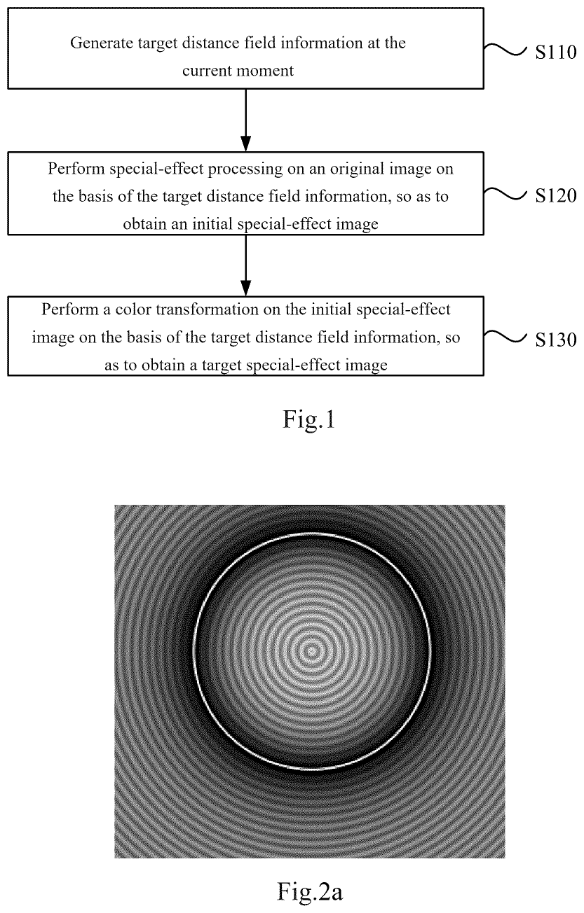

FIG. 1 is a schematic flowchart of a generation method for an effect image according to an embodiment of the present disclosure. The embodiment of the present disclosure is applicable to a situation of carrying out effect processing on an image; the method may be performed by a generation apparatus for the effect image, and the apparatus may be implemented in software or hardware, optionally, implemented by an electronic device which may be a mobile terminal, a PC terminal or a server and the like.

As shown in FIG. 1, the method includes:

S110, generating target distance field information at a current moment.

The distance field information may be understood as signed distance field information, which represents the distance between a pixel point in a screen coordinate system and a certain surface (an edge line in a two-dimensional space); if the pixel point is located inside an edge, the distance field information is negative; and if the pixel point is located outside the edge, the distance field information is positive.

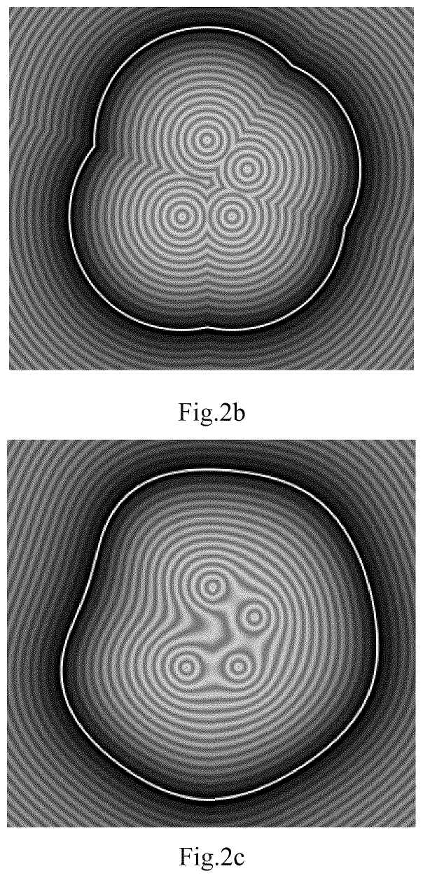

In the embodiment, the target distance field information may be obtained by fusing at least one initial distance field information. Exemplarily, FIG. 2a is a schematic diagram of a circular distance field, and as shown in FIG. 2a, the distance between each pixel point on the circular ring and the edge line is equal. FIG. 2b is a schematic diagram of four circular distance fields after fusion, and as shown in FIG. 2b, the four circular distance fields are fused to form distance field information in an irregular shape.

Specifically, the mode of generating the target distance field information at the current moment may be: acquiring corresponding time information at the current moment; adjusting at least one set edge based on the time information; determining at least one initial distance field information according to at least one adjusted set edge; and fusing the at least one initial distance field information to obtain the target distance field information.

The set edge is an edge line in a set shape. The set shape may be a regular shape, such as circle, and rectangle; and it may also be an irregular shape. The time information may be understood as timestamp information corresponding to a current video frame. In the embodiment, in order to simulate water drops, the set shape may be selected to be the circle. In the embodiment, the process of adjusting at least one set edge based on the time information may be: performing a linear transformation on the time information to obtain an adjustment amount, and then adjusting the size and/or position of the set edge according to the adjustment amount, so as to obtain an adjusted set edge. Exemplarily, if the shape of the set edge is a circle, the radius and the center point of the circle may be adjusted based on the time information so as to realize adjustment of the size and the position of the edge of the circle. If the shape of the set edge is a rectangle, the center point, the length and the width of the rectangle are adjusted based on the time information so as to realize adjustment of the size and the position of the edge of the rectangle.

Specifically, the process of determining the at least one initial distance field information according to at least one adjusted set edge may be: for each adjusted set edge, calculating the shortest directed distance value between each pixel point and the set edge so as to obtain the initial distance field information corresponding to the set edge. Exemplarily, for the edge of the circle, the distance between the pixel point and the circle center is calculated, and then the difference between the distance and the radius of the circle is obtained, so as to obtain the directed distance value of the pixel point relative to the edge of the circle.

Optionally, the set shape is a circle, and the set edge includes circle center point information and radius information; and the mode of adjusting at least one set edge based on the time information may be: adjusting the circle center point information and/or the radius information based on the time information. Correspondingly, the process of determining at least one initial distance field information according to at least one adjusted set edge may be: determining a directed distance between the pixel point and the at least one adjusted set edge, so as to obtain the at least one initial distance field information.

The circle center point information may be represented by a circle center point coordinate, and the radius information may be understood as the length of the radius. Specifically, the process of adjusting the circle center point information and/or the radius information based on the time information may be: for the set edge of each circle, firstly, performing a linear transformation on the time information to obtain an adjustment amount; multiplying the adjustment amount by the initial radius, so as to obtain adjusted radius information; and/or multiplying the adjustment amount by the initial circle center point coordinates, so as to obtain adjusted circle center point information, thereby obtaining an adjusted set edge. Finally, the directed distance between the pixel point and the at least one adjusted set edge is determined to obtain at least one initial distance field information. The initial circle center point coordinate may be randomly selected, and a plurality of initial circle center point coordinates are not overlapped, for example, it is assumed that there are four initial circle center points, the four initial circle center points may be four vertexes of a five-pointed star. In the embodiment, at least one set edge is adjusted based on the time information, so that the distance field information changes along with time, and the effect in the video generated by the effect image has the effect of dynamically changing along with time.

Optionally, the mode of determining at least one initial distance field information according to at least one adjusted set edge may be: acquiring first initial position information of the pixel point; determining first angle information based on the first initial position information; transforming the first initial position information based on the first angle information and the time information, so as to obtain first target position information; and determining the directed distance between the pixel point and the at least one adjusted set edge based on the first target position information, so as to obtain the at least one initial distance field information.

The first initial position information may be understood as UV coordinates of the pixel point in a screen. The mode of determining first angle information based on the first initial position information may be: dividing a vertical coordinate Y of the first initial position information by a horizontal coordinate X of the first initial position information, so as to obtain a quotient (Y/X), and then finding an inverse tangent of the quotient, namely, the first angle information=arctan (Y/X).

Specifically, the process of transforming the first initial position information based on the first angle information and the time information, so as to obtain first target position information may be: determining a transformation amount based on the first angle information and the time information, and then multiplying the transformation amount by the first initial position information, so as to obtain the target position information. The process of determining a transformation amount based on the first angle information and the time information may be: firstly performing weighted summation on the first angle information and the time information, performing sine operation on a weighted summation result, and performing a linear transformation on a sine result to obtain a fusion coefficient; then preprocessing the time information; and finally fusing a preprocessed time information and a first set value based on the fusion coefficient, so as to obtain the transformation amount. The process of preprocessing the time information may be: firstly performing smooth transition processing on the time information to obtain a value between 0 and 1, and then fusing the first set value and a second set value based on the time information after the smooth transition processing, so as to obtain a preprocessed time information. The first set value and the second set value are set by the user, for example, the first set value is 1, and the second set value is 0.95. Specifically, after the first target position information is obtained, the directed distance between the first target position and the at least one adjusted set edge is calculated, so that at least one initial distance field information is obtained. In the embodiment, the initial distance field information is determined by transforming the first initial position information of the pixel point, so that the diversity of the distance field may be improved.

Optionally, the mode of fusing the at least one initial distance field information to obtain the target distance field information may be: determining a minimum value in the at least one initial distance field information as the target distance field information; or, calling a set smooth fusion function to fuse the at least one initial distance field information, so as to obtain the target distance field information.

The process of calling a set smooth fusion function to fuse the at least one initial distance field information may be: calling a set smooth fusion function to fuse two of the initial distance field information, then calling the set smooth fusion function to fuse the previous fusion result and a third initial distance field information, and so on until all the initial distance field information is fused. In the embodiment, when the set smooth fusion function is called to fuse the at least one initial distance field information, the fusion coefficient needs to be determined at first, and then the at least one initial distance field information is fused based on the fusion coefficient. The fusion coefficient may be any value between 0 and 1, for example, 0.35. In this application scene, it is assumed that the set smooth fusion function is expressed as smin (d1, d2, a), in which, d1 and d2 are two distance field information to be fused, and a is a fusion coefficient. Exemplarily, FIG. 2c is an example diagram of a fused distance field according to the embodiment. As shown in FIG. 2c, the fused distance field is smoother in transition. In the embodiment, the set smooth fusion function is called to fuse the at least one initial distance field information, so that the reality sense of the water drop effect generated the subsequently may be enhanced.

S120, performing an effect processing on an original image based on the target distance field information, so as to obtain an initial effect image.

In the embodiment, the process of performing an effect processing on an original image based on the target distance field information may be understood as follows: resampling the color values of pixel points in an original image based on the target distance field information, so as to obtain an initial effect image, so that an area of the initial effect image corresponding to an edge area in the target distance field presents a distorted effect.

Specifically, the mode of performing an effect processing on an original image based on the target distance field information, so as to obtain an initial effect image may be: acquiring second initial position information of the pixel points in an original image; transforming the second initial position information based on the target distance field information, so as to obtain intermediate position information; superposing the intermediate position information and the second initial position information based on the target distance field information, so as to obtain second target position information; and sampling the original image based on the second target position information, so as to obtain an initial effect image.

The second initial position information may be understood as UV coordinates of the pixel points in a screen coordinate system, and the target distance field information includes a directed distance of each pixel point. Therefore, transforming the second initial position information based on the target distance field information may be understood as follows: transforming the UV coordinates of the pixel points according to the directed distances corresponding to the pixel points.

In the embodiment, the mode of transforming the second initial position information based on the target distance field information, so as to obtain intermediate position information may be: determining distance information between the pixel points and the set point based on the second initial position information; and transforming the second initial position information according to the distance information and the target distance field information, so as to obtain intermediate position information.

The set point may be a central point of the screen or a point selected by the user according to effect requirements, and the process of determining distance information between the pixel points and the set point based on the second initial position information may be: calculating a distance between the UV coordinates corresponding to the second initial position information and the UV coordinates of the set point. In the embodiment, the process of transforming the second initial position information according to the distance information and the target distance field information may be: performing tangent operation on the distance information; and then performing a first transformation on the second initial position information based on a tangent result, so as to obtain transformed position information; then performing set index operation on the target distance field information to obtain a fusion coefficient; and fusing the transformed position information and the second initial position information based on the fusion coefficient, so as to obtain an intermediate position information. In the embodiment, the second initial position information is transformed according to the distance information and the target distance field information, so that the generated effect image may present a fisheye distortion effect.

In the embodiment, the mode of superposing the intermediate position information and the second initial position information based on the target distance field information, so as to obtain second target position information may be: performing first smooth transition processing on the target distance field information to obtain a superposition coefficient; and superposing the intermediate position information and the second initial position information based on the superposition coefficient, so as to obtain second target position information.

The mode of performing first smooth transition processing on the target distance field information may be processing a target distance field by a smooth transition function to transform the target distance field into a value of 0-1. The smooth processing function may be a smoothstep (a, b, c) function, in which a and b are parameters, and c is the amount to be smoothed. Specifically, the process of superposing the intermediate position information and the second initial position information based on the superposition coefficient may be: taking the superposition coefficient as a weighting coefficient of the intermediate position information, taking a result of subtracting the superposition coefficient from 1 as a weighting coefficient of the second initial position information, and finally performing weighted summation on the intermediate position information and the second initial position information based on the weighting coefficients, so as to obtain the target position information. In the embodiment, the intermediate position information and the second initial position information are superposed based on the target distance field information so that the distortion range of the original image may be determined, and thus the precision of effect processing may be improved.

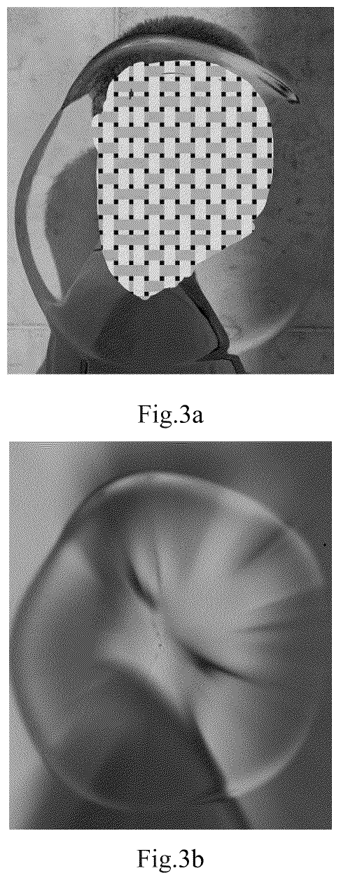

In the embodiment, after the target position information of each pixel point is obtained, the pixel value is sampled from the original image based on the target position information, and thus the initial effect image may be obtained. Exemplarily, FIG. 3a is an example diagram of an initial effect image according to the embodiment. As shown in FIG. 3a, the original image is resampled based on the distance field information to generate an image with a water drop effect. In the embodiment, an edge area may be obtained through the distance field, and the generated water drop is more real by performing the distortion processing on the area corresponding to the edge area in the original image.

S130, performing a color transformation on the initial effect image based on the target distance field information, so as to obtain a target effect image.

In the embodiment, performing a color transformation on the initial effect image based on the target distance field information may be understood as follows: adjusting the color information of each pixel point in the initial effect image through the target distance field information, so that the target effect image presents a rainbow effect.

Specifically, the mode of performing a color transformation on the initial effect image based on the target distance field information, so as to obtain a target effect image may be: acquiring gray value and second angle information of the pixel points in the initial effect image; generating a color image corresponding to the initial effect image based on the gray value and the second angle information; and fusing the color image and the original image based on the target distance field information, so as to obtain a target effect image.

The gray value of the pixel points may be obtained by performing a set weighted calculation on three-color channel value of the pixel points. The second angle information of the pixel points may be determined by means of the UV coordinates of the pixel points in the screen, and the calculating process may be expressed as: the second angle information=arctan (Y/X), in which, Y represents a vertical coordinate, and X represents a horizontal coordinate.

Specifically, the process of acquiring gray value and the second angle information of the pixel points in the initial effect image may be: firstly, performing a radiation fuzzy processing on the initial effect image to obtain a fuzzy effect image, and then acquiring the gray value and the second angle information of each pixel point in the fuzzy effect image. The radiation fuzzy processing is a type of mirror image fuzzy processing, any mirror image fuzzy processing mode may be adopted for processing, which is not limited here. Exemplarily, FIG. 3b is an example diagram of the fuzzy effect figure according to the embodiment, and as shown in FIG. 3b, the fuzzy figure presents a radiation effect.

In the embodiment, the process of generating a color image corresponding to the initial effect image based on the gray value and second angle information may be understood as follows: determining HSV (hue, saturation and brightness) color information corresponding to the initial effect image based on the gray value and the second angle information. Specifically, it includes: setting a saturation(S) value and a brightness (V) value, then for each pixel point, firstly, performing sine operation on second angle information, and then performing linear superposition on a sine result and the gray value to obtain a hue (H) value of the pixel point, so as to obtain a color image corresponding to the initial effect image. Exemplarily, FIG. 3c is an example diagram of the color image corresponding to the initial effect image according to the embodiment, as shown in FIG. 3c, the original image is the color image which corresponds to the initial effect image in FIG. 3b.

In the embodiment, the mode of fusing the color image and the original image based on the target distance field information, so as to obtain a target effect image may be: performing a second smoothing transition processing on the target distance field information to obtain a fusion coefficient; and fusing the color image and the original image based on the fusion coefficient, so as to obtain a target effect image.

The mode of performing a second smooth transition processing on the target distance field information may be: processing the target distance field twice by using a smooth transition function so as to transform the target distance field into a value between 0 and 1, and then multiplying the values obtained after two times of smooth transition processing, so as to obtain a fusion coefficient. The smooth processing function may be a smoothstep () function, and the parameters in the two times of smooth transition processing are different; and exemplarily, and the range of the parameters in a first smooth transition processing may be (−0.2, 0), and the range of the parameters in a second smooth transition processing may be (−0.1, 0.15). Specifically, the process of fusing the color image and the original image based on the fusion coefficient, so as to obtain a target effect image may be: taking the fusion coefficient as a weighting coefficient of the color image, taking a result of subtracting the fusion coefficient from 1 as a weighting coefficient of the original image, and finally fusing the color image and the original image based on the weighting coefficients, so as to obtain a target effect image. Exemplarily, FIG. 3d is an example diagram of the target effect image according to the embodiment, as shown in FIG. 3d, the effect with the rainbow water drops is generated in the original image.

Optionally, after generating a target distance field information at a current moment, the method further includes the following steps: splitting the target distance field information into first sub-distance field information and second sub-distance field information; and storing the first sub-distance field information and the second sub-distance field information in two data channels respectively.

In an image scene, each color channel (RGBA) in the image has 8-bit precision, and data is usually stored in one color channel at the 8-bit precision, so that the precision of the stored data is low, and the quality of the image is influenced. In the embodiment, the target distance field information is split into two 8-bit precision values, namely the first sub-distance field information and the second sub-distance field information, and the first sub-distance field information and the second sub-distance field information are respectively stored in the two data channels, so that the data storage precision may be improved, the image quality is improved, and the image is prevented from sawteeth.

In the embodiment, the mode of splitting the target distance field information into a first sub-distance field information and a second sub-distance field information may be: multiplying the target distance field information by a set value, so as to obtain a multiplication result, then dividing the positive part of the multiplication result by the set value, so as to obtain the first sub-distance field information, and taking the decimal part of the multiplication result as the second sub-distance field information. The set value may be 255.

Optionally, the mode of storing the first sub-distance field information and the second sub-distance field information in two data channels respectively may be: if the target distance field information is a positive value, storing the first sub-distance field information in the first data channel, and storing the second sub-distance field information in the second data channel; and if the target distance field information is a negative value, storing the first sub-distance field information in a third data channel, and storing the second sub-distance field information in a fourth data channel.

The first data channel may be a R channel, the second data channel may be a G channel, the third data channel may be a B channel, and the fourth data channel may be an A channel. Specifically, if the target distance field information is a positive value, the first sub-distance field information and the second sub-distance field information are respectively stored in the R channel and the G channel; and if the target distance field information is a negative value, the first sub-distance field information and the second sub-distance field information are respectively stored in the B channel and the A channel. In the embodiment, they are stored in the corresponding data channels according to the positive and negative properties of the target distance field information, so that the direction of the target distance field information may be better distinguished, facilitating the subsequent correct reading of the target distance field information.

According to the technical solution of the embodiment of the present disclosure, the generation method for the effect image includes: generating a target distance field information at a current moment; performing effect processing on an original image based on the target distance field information, so as to obtain an initial effect image; and performing a color transformation on the initial effect image based on the target distance field information, so as to obtain a target effect image. According to the generation method for the effect image provided by the embodiment of the present disclosure, the effect processing and the color transformation are performed on the original image based on the distance field information, and the distance field may be similar to the distance field of the water drop, so that the effect image with the water drop effect may be generated, the content of the image is enriched, and the display effect of the image is improved.

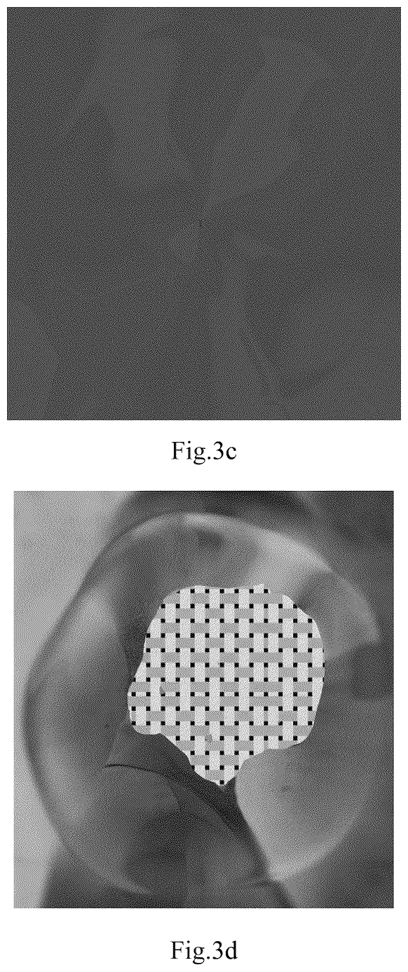

FIG. 4 is a structural schematic diagram of a generation apparatus for an effect image according to an embodiment of the present disclosure, as shown in FIG. 4, the apparatus includes:
a target distance field information generation module 410 configured to generate target distance field information at a current moment;
an initial effect image acquisition module 420 configured to perform effect processing on an original image based on the target distance field information, so as to obtain an initial effect image; and
a target effect image acquisition module 430 configured to perform a color transformation on the initial effect image based on the target distance field information, so as to obtain a target effect image.

Optionally, the target distance field information generation module 410 is further configured to:
acquire corresponding time information at the current moment;
adjust at least one set edge based on the time information, wherein the set edge is an edge line of a set shape;
determine at least one initial distance field information according to at least one adjusted set edge; and
fuse the at least one initial distance field information to obtain the target distance field information.

Optionally, the set shape is a circle, and the set edge includes circle center point information and radius information; the target distance field information generation module 410 is further configured to:
adjust the circle center point information and/or the radius information based on the time information; and
the determining at least one initial distance field information according to at least one adjusted set edge, includes:
determining a directed distance between a pixel point and the at least one adjusted set edge, so as to obtain the at least one initial distance field information.

Optionally, the target distance field information generation module 410 is further configured to:
acquire first initial position information of the pixel point;
determine first angle information based on the first initial position information;
transform the first initial position information based on the first angle information and the time information, so as to obtain first target position information; and
determine the directed distance between the pixel point and the at least one adjusted set edge based on the first target position information, so as to obtain the at least one initial distance field information.

Optionally, the target distance field information generation module 410 is further configured to:
determine a minimum value in the at least one initial distance field information as the target distance field information; or,
call a set smooth fusion function to fuse the at least one initial distance field information, so as to obtain the target distance field information.

Optionally, the initial effect image acquisition module 420 is further configured to:
acquire second initial position information of the pixel point in the original image;
transform the second initial position information based on the target distance field information, so as to obtain intermediate position information;
superpose the intermediate position information and the second initial position information based on the target distance field information, so as to obtain second target position information; and
sample the original image based on the second target position information, so as to obtain the initial effect image.

Optionally, the initial effect image acquisition module 420 is further configured to:
determine a distance information between the pixel point and the set point based on the second initial position information; and
transform the second initial position information according to the distance information and the target distance field information, so as to obtain the intermediate position information.

Optionally, the initial effect image acquisition module 420 is further configured to:
perform first smooth transition processing on the target distance field information to obtain a superposition coefficient; and
superpose the intermediate position information and the second initial position information based on the superposition coefficient, so as to obtain the second target position information.

Optionally, the target effect image acquisition module 430 is further configured to:
acquire gray value and second angle information of the pixel point in the initial effect image;
generate a color image corresponding to the initial effect image based on the gray value and the second angle information; and
fuse the color image and the original image based on the target distance field information to obtain the target effect image.

Optionally, the target effect image acquisition module 430 is further configured to:
perform second smoothing transition processing on the target distance field information to obtain a fusion coefficient; and
fuse the color image and the original image based on the fusion coefficient, so as to obtain the target effect image.

Optionally, the apparatus further includes: a target distance field information storage module, which is configured to:
split the target distance field information into first sub-distance field information and second sub-distance field information; and
store the first sub-distance field information and the second sub-distance field information in two data channels, respectively.

Optionally, the target distance field information storage module is further configured to:
if the target distance field information is a positive value, store the first sub-distance field information in a first data channel, and store the second sub-distance field information in a second data channel; and
if the target distance field information is a negative value, store the first sub-distance field information in a third data channel, and store the second sub-distance field information in a fourth data channel.

The generation apparatus for the effect image provided in the embodiment of the present disclosure may perform the generation method for the effect image provided in any embodiment of the present disclosure, and has corresponding functional modules and beneficial effects obtained by performing the method.

It is to be noted that all units and modules included in the apparatus are only divided according to functional logic, but are not limited to the above-mentioned division, as long as the corresponding functions may be realized; in addition, the specific names of the functional units are only for the convenience of distinguishing them from each other and are not intended to limit the scope of protection of this present disclosure.

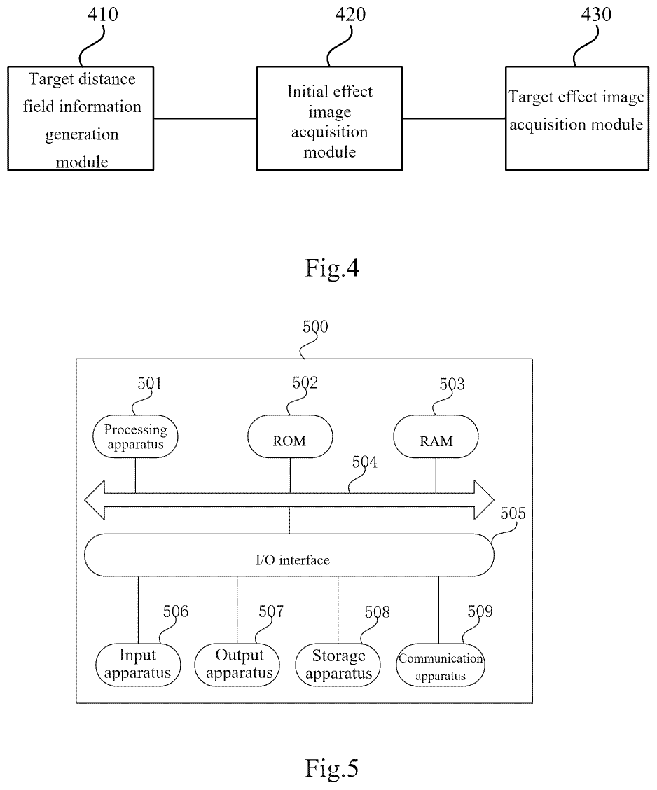

FIG. 5 is a schematic structural diagram of an electronic device provided by embodiments of the present disclosure. Referring to FIG. 5, it illustrates the structural schematic diagram of the electronic device which is suitable for implementing the electronic device (e.g., the terminal device or server in FIG. 5) according to the embodiment of the present disclosure. The electronic devices in some embodiments of the present disclosure may include but are not limited to mobile terminals such as a mobile phone, a notebook computer, a digital broadcasting receiver, a personal digital assistant (PDA), a tablet computer (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of messages or information exchanged between multiple apparatuses in the embodiment of present disclosure are for illustrative purposes only and are not intended to limit the scope of such messages or information.

An electronic device provided by the embodiment of the present disclosure and the generation method for the effect image provided in the above embodiment belong to the same invention idea, and the technical details not described in detail in the embodiment may be referred to the above embodiment, and the embodiment has the same beneficial effect as the above embodiment.

An embodiment of the present disclosure provides a computer storage medium on which a computer program is stored; and in response to that the program is executed by a processor, the generation method for the effect image provided in the above embodiment is performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:.

The above-mentioned computer-readable medium carries one or more programs, and when the one or more programs are executed by the electronic device, the electronic device is caused to: generating target distance field information at a current moment; performing an effect processing on an original image based on the target distance field information, so as to obtain an initial effect image; performing a color transformation on the initial effect image based on the target distance field information, so as to obtain a target effect image.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the unit does not constitute a limitation of the unit itself under certain circumstances. For example, a first obtaining unit may also be described as a “unit for obtaining at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a post visibility permission setting method is provided, comprising:

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A generation method for an effect image, comprising:
generating target distance field information at a current moment;
performing effect processing on an image based on the target distance field information, so as to obtain a first effect image; and
performing a color transformation on the first effect image based on the target distance field information, so as to obtain a second effect image.

2. The method according to claim 1, wherein the generating target distance field information at a current moment, comprises:
acquiring corresponding time information at the current moment;
adjusting at least one set edge based on the time information, wherein the set edge is an edge line of a set shape;
determining at least one initial distance field information according to at least one adjusted set edge; and
fusing the at least one initial distance field information to obtain the target distance field information.

3. The method according to claim 2, wherein the set shape is a circle, and the set edge comprises circle center point information and radius information;
the adjusting at least one set edge based on the time information, comprises:
adjusting the circle center point information and/or the radius information based on the time information; and
the determining at least one initial distance field information according to at least one adjusted set edge, comprises:
determining a directed distance between a pixel point and the at least one adjusted set edge, so as to obtain the at least one initial distance field information.

4. The method according to claim 2, wherein the determining at least one initial distance field information according to at least one adjusted set edge, comprises:
acquiring first initial position information of the pixel point;
determining first angle information based on the first initial position information;
transforming the first initial position information based on the first angle information and the time information, so as to obtain first target position information; and
determining the directed distance between the pixel point and the at least one adjusted set edge based on the first target position information, so as to obtain the at least one initial distance field information.

5. The method according to claim 2, wherein the fusing the at least one initial distance field information to obtain the target distance field information, comprises:
determining a minimum value in the at least one initial distance field information as the target distance field information; or,
calling a set smooth fusion function to fuse the at least one initial distance field information, so as to obtain the target distance field information.

6. The method according to claim 1, wherein the performing effect processing on an image based on the target distance field information, so as to obtain a first effect image, comprises:
acquiring second initial position information of the pixel point in the image;
transforming the second initial position information based on the target distance field information, so as to obtain intermediate position information;
superposing the intermediate position information and the second initial position information based on the target distance field information, so as to obtain second target position information; and
sampling the image based on the second target position information, so as to obtain the first effect image.

7. The method according to claim 6, wherein the transforming the second initial position information based on the target distance field information, so as to obtain intermediate position information, comprises:
determining a distance information between the pixel point and a set point based on the second initial position information; and
transforming the second initial position information according to the distance information and the target distance field information, so as to obtain the intermediate position information.

8. The method according to claim 6, wherein the superposing the intermediate position information and the second initial position information based on the target distance field information, so as to obtain second target position information, comprises:
performing first smooth transition processing on the target distance field information to obtain a superposition coefficient; and
superposing the intermediate position information and the second initial position information based on the superposition coefficient, so as to obtain the second target position information.

9. The method according to claim 1, wherein the performing a color transformation on the first effect image based on the target distance field information, so as to obtain a second effect image, comprises:
acquiring gray value and second angle information of thee pixel point in the first effect image;
generating a color image corresponding to the first effect image based on the gray value and the second angle information; and
fusing the color image and the image based on the target distance field information, so as to obtain the second effect image.

10. The method according to claim 9, wherein the fusing the color image and the image based on the target distance field information, so as to obtain the second effect image, comprises:
performing second smoothing transition processing on the target distance field information to obtain a fusion coefficient; and
fusing the color image and the image based on the fusion coefficient, so as to obtain the second effect image.

11. The method according to claim 1, wherein after the generating target distance field information at a current moment, the method further comprises:
splitting the target distance field information into first sub-distance field information and second sub-distance field information; and
storing the first sub-distance field information and the second sub-distance field information in two data channels, respectively.

12. The method according to claim 11, wherein the storing the first sub-distance field information and the second sub-distance field information in the two data channels, respectively, comprises:
if the target distance field information is a positive value, storing the first sub-distance field information in a first data channel, and storing the second sub-distance field information in a second data channel; and
if the target distance field information is a negative value, storing the first sub-distance field information in a third data channel, and storing the second sub-distance field information in a fourth data channel.

13. (canceled)

14. An electronic device, comprising:
one or more processors; and
a storage device configured to store one or more computer programs,
wherein when the one or more computer programs are executed by the one or more processors, the one or more processors implement a generation method for an effect image, comprising:
generating target distance field information at a current moment;
performing effect processing on an image based on the target distance field information, so as to obtain a first effect image; and
performing a color transformation on the first effect image based on the target distance field information, so as to obtain a second effect image.

15. A storage medium containing computer-executable instructions, wherein the computer-executable instructions, when executed by a computer processor, implement a generation method for an effect image, comprising:
generating target distance field information at a current moment;
performing effect processing on an image based on the target distance field information, so as to obtain a first effect image; and
performing a color transformation on the first effect image based on the target distance field information, so as to obtain a second effect image.

16. The electronic device according to claim 14, wherein the generating target distance field information at a current moment, comprises:
acquiring corresponding time information at the current moment;
adjusting at least one set edge based on the time information, wherein the set edge is an edge line of a set shape;
determining at least one initial distance field information according to at least one adjusted set edge; and
fusing the at least one initial distance field information to obtain the target distance field information.

17. The electronic device according to claim 16, wherein the set shape is a circle, and the set edge comprises circle center point information and radius information;
the adjusting at least one set edge based on the time information, comprises:
adjusting the circle center point information and/or the radius information based on the time information; and
the determining at least one initial distance field information according to at least one adjusted set edge, comprises:
determining a directed distance between a pixel point and the at least one adjusted set edge, so as to obtain the at least one initial distance field information.

18. The electronic device according to claim 16, wherein the determining at least one initial distance field information according to at least one adjusted set edge, comprises:
acquiring first initial position information of the pixel point;
determining first angle information based on the first initial position information;
transforming the first initial position information based on the first angle information and the time information, so as to obtain first target position information; and
determining the directed distance between the pixel point and the at least one adjusted set edge based on the first target position information, so as to obtain the at least one initial distance field information.

19. The electronic device according to claim 16, wherein the fusing the at least one initial distance field information to obtain the target distance field information, comprises:
determining a minimum value in the at least one initial distance field information as the target distance field information; or,
calling a set smooth fusion function to fuse the at least one initial distance field information, so as to obtain the target distance field information.

20. The electronic device according to claim 14, wherein the performing effect processing on an image based on the target distance field information, so as to obtain a first effect image, comprises:
acquiring second initial position information of the pixel point in the image;
transforming the second initial position information based on the target distance field information, so as to obtain intermediate position information;
superposing the intermediate position information and the second initial position information based on the target distance field information, so as to obtain second target position information; and
sampling the image based on the second target position information, so as to obtain the first effect image.

21. The electronic device according to claim 14, wherein the performing a color transformation on the first effect image based on the target distance field information, so as to obtain a second effect image, comprises:
acquiring gray value and second angle information of thee pixel point in the first effect image;
generating a color image corresponding to the first effect image based on the gray value and the second angle information; and
fusing the color image and the image based on the target distance field information, so as to obtain the second effect image.
